(19) United States
(12) Patent Application Publication
(10) Pub. No.: US 2026/0213371 A1
(43) Pub. Date: Jul. 23, 2026

(54) SECONDARY CELL

(71) Applicant: Northvolt AB, Stockholm (SE)

(72) Inventors: Michael SHAUGHNESSY, Västerås (SE); Maria Vittoria ZUCCOLI, Stockholm (SE)

(21) Appl. No.: 19/142,211

(22) PCT Filed: Dec. 20, 2023
(86) PCT No.: PCT/EP2023/086867

§ 371 Date: Jun. 22, 2025

(30) Foreign Application Priority Data
Dec. 23, 2022 (SE) 2251580-3

(51) Int. Cl. H01M 50/538; H01M 10/04; H01M 50/107; H01M 50/152; H01M 50/167; H01M 50/528; H01M 50/533

(52) U.S. Cl. CPC H01M 50/538; H01M 10/0431; H01M 50/107; H01M 50/152; H01M 50/528; H01M 50/533; H01M 50/167

(57) ABSTRACT

There is disclosed herein a cylindrical secondary cell (1) and methods for manufacturing the cylindrical secondary cell. The cylindrical secondary cell comprises a cylindrical can (2) having a beading groove (3) formed in a wall of the cylindrical can (2) and arranged around the circumference of the cylindrical can (2), and a first conductive sheet (4), with first electrode coating (4a), wound to form a jelly roll (5) which is arranged in the cylindrical can (2), and wherein the first conductive sheet (4) comprises a portion free of first electrode coating (4a) which protrudes on a first end side (5a) of the jelly roll (5). The cylindrical secondary cell further comprises a current collector disc (6) which is electrically conductive and arranged at the first end side (5a) of the jelly roll (5) and in direct contact with at least part of the portion free of first electrode coating (4a) of the first conductive sheet (4), wherein the current collector disc (6) abuts the apex of the beading groove.

### TECHNICAL FIELD

The present disclosure generally pertains to secondary cells and, more particularly, to a secondary cell wherein a current collector disc of the secondary cell abuts an apex of a beading groove formed around the cylindrical can of the secondary cell.

### BACKGROUND

In addressing climate change, there is an increasing demand for rechargeable batteries, e.g. to enable electrification of transportation and to supplement renewable energy. Currently, lithium-ion batteries are becoming increasingly popular. They represent a type of rechargeable battery in which lithium ions move from the negative electrode to the positive electrode during discharge and back when charging.

As the demand for rechargeable batteries increases, more and more focus is being placed on production speed and cost. To achieve an effective production of rechargeable batteries, the design of the batteries as well as their manufacturing process can be optimized.

### SUMMARY

In view of at least the above considerations, there is provided, according to aspects of the present disclosure, an arrangement for a current collector disc of a secondary cell to be reliably in mechanical and/or electrical contact with a beading groove of the cylindrical can forming the housing for the secondary cell.

In particular, according to an aspect of the present disclosure, there is provided a cylindrical secondary cell (also referred to herein as a ‘secondary cell’ or simply ‘cell’) comprising a cylindrical can with a beading groove formed in a wall of the cylindrical can and arranged around the circumference of the cylindrical can.

The cell further comprises a first conductive sheet, with first electrode coating, wound to form a jelly roll which is arranged in the cylindrical can, and wherein the first conductive sheet comprises a portion free of first electrode coating which protrudes on a first end side of the jelly roll, and a current collector disc which is electrically conductive and arranged at the first end side of the jelly roll and in direct contact with at least part of the portion free of first electrode coating of the first conductive sheet.

According to a particularly advantageous aspect of the present disclosure, the current collector disc abuts the apex of the beading groove.

In an example refinement, the current collector disc comprises a peripheral flange extending away from the jelly roll, wherein peripheral flange of the current collector disc is configured to match and abut the apex of the beading groove.

As a result of such an approach, the current collector disc can be secured in its position during the beading process. Also, the current collector disc and the beading groove can form a reliable electrical and thermal connection so that they can be welded together at the beading groove.

Moreover, as the current collector disc is sized to match the apex of the beading groove, the current collector disc may be dimensioned (i.e., in terms of its radius) smaller, the apex of the beading groove being the radially innermost part thereof. Hence, material usage may be reduced in the manufacture of the current collector disc.

In some examples, a portion of the peripheral flange of the current collector disc is bent and pressed inwards, towards a center of the cylindrical can, by the beading groove. Thus, the current collector disc may be reliably held in the cylindrical can and against the jelly roll.

Further, in some examples, the cylindrical can has an open end for receiving a lid, and the surface of the peripheral flange closest to the edge of the current collector disc is angled towards said open end. Therefore, the current collector disc may be welded to the cylindrical can at the beading groove by directing a welding laser from outside the cylindrical can during a manufacture of the cell.

The cell may further comprise a lid that rests on the beading groove. The lid and the current collector disc may contact each other or may be electrically insulated from each other, depending on the implementation. The lid closes the open end of the cylindrical can and may be attached thereto by laser welding or by crimping. In some other examples, the lid rests on a brim of the open end of the cylindrical can or surrounds said brim with a flange.

In an example, the current collector disc comprises at least one slit arranged in the peripheral flange and at least the edge of the current collector disc. If the peripheral flange of the current collector disc is deformed by the beading groove when abutting, the at least one slit may be used to reduce stress in the current collector disc that may arise from the forces in said deformation. The at least one slit is, for example, cut out of the current collector disc. If the flange is made in a stamping process, the at least one slit may be made before the stamping or in the same process.

According to a further aspect of the present disclosure, there is provided a method for assembling the cylindrical secondary cell substantially as described above, wherein the assembling the cylindrical secondary cell comprises arranging the jelly roll in the cylindrical can, arranging the current collector disc in the cylindrical can so that at least part of the portion free of first electrode coating of the first conductive sheet is in direct contact with the current collector disc. The method then comprises beading the cylindrical can to form the beading groove so that the peripheral flange of the current collector disc, having a shape that matches the apex of the beading groove, abuts the beading groove at least at said apex of the beading groove.

Put another way, according to this method, the shape of the beading groove of the cylindrical can and the shape of the peripheral flange of the current collector disc may be separately formed.

According to another aspect of the present disclosure, there is provided a method for assembling the cylindrical secondary cell substantially as described above, wherein the assembling the cylindrical secondary cell comprises arranging the jelly roll in the cylindrical can, and arranging the current collector disc in the cylindrical can so that at least part of the portion free of first electrode coating of the first conductive sheet is in direct contact with the current collector disc. The method then comprises beading the cylindrical can to form the beading groove at a position on the cylindrical can so that the peripheral flange of the current collector disc is shaped by said beading thereby to match and abut the beading groove at least at the apex of the beading groove.

Put another way, according to this method, the shape of the beading groove of the cylindrical can and the shape of the peripheral flange of the current collector disc may be formed at a same time during the beading process.

In some implementations, a sizing process may be performed on the cylindrical can. Sizing comprises bending or pressing the cylindrical can so as to reduce one or more of its dimensions. For example, after beading, the cylindrical can may be sized by axially compressing the can to thereby collapse the beading groove in the axial direction, which may also cause the beading groove to move radially inwards. Thus, such a sizing operation may improve the volumetric efficiency of the cell.

According to a further aspect of the present disclosure, there is provided a method for assembling the cylindrical secondary cell substantially as described above, wherein the assembling the cylindrical secondary cell comprises arranging the jelly roll in the cylindrical can, and arranging the current collector disc in the cylindrical can so that at least part of the portion free of first electrode coating of the first conductive sheet is in direct contact with the current collector disc. The method then comprises beading the cylindrical can to form the beading groove, and sizing the cylindrical can so that the current collector disc abuts the beading groove at least at the apex of the beading groove.

A further step of welding the current collector disc to the cylindrical can at the beading groove may be added to any of the above described methods.

Welding the current collector disc to the cylindrical can at the beading groove may comprise directing a welding laser into an open end of the cylindrical can, or directing a welding laser at an outer surface of the beading groove. According to the former option, a reliable weld may be formed without risk of damage to an outer surface of the cylindrical can, and in a manner that may allow for inspection of the weld. According to the latter option, a weld may be formed without forming particles within the confines of the cylindrical can, and the outer welded surface may then be hidden by a sizing process.

### BRIEF DESCRIPTION OF THE DRAWINGS

Aspects of the present disclosure will be described, by way of example only, and with reference to the following figures, in which:

FIG. 1 shows a cross-sectional view of an example cylindrical secondary cell wherein a current collector disc and a jelly roll are secured in place in the cylindrical can by a beading groove;

FIG. 2 shows a zoomed portion of the example cylindrical secondary cell shown in FIG. 1;

FIG. 3 shows a corresponding portion of an example cylindrical secondary cell as that shown in FIG. 2, wherein the beading groove and the current collector disc have an alternative configuration;

FIGS. 4a and 4b show a similar portion of a cylindrical secondary cell as FIGS. 2 and 3, before and after a sizing operation performed on the cylindrical can;

FIG. 5 shows a cylindrical can where a jelly roll is being inserted and an electrode lead plate is being put on top, according to an example method of manufacturing a cylindrical secondary cell;

FIG. 6 shows when the electrode lead plate has been arranged against the first end side of the jelly roll;

FIG. 7 shows when the jelly roll and the electrode lead plate have been inserted fully into the cylindrical can; and

FIG. 8 shows the cylindrical can after beading and how the beading groove is arranged at a position on the cylindrical can so that the peripheral flange of the current collector disc matches and abuts the apex of the beading groove.

### DETAILED DESCRIPTION

The present disclosure is described in the following by way of a number of illustrative examples. It will be appreciated that these examples are provided for illustration and explanation only and are not intended to be limiting on the scope of the disclosure.

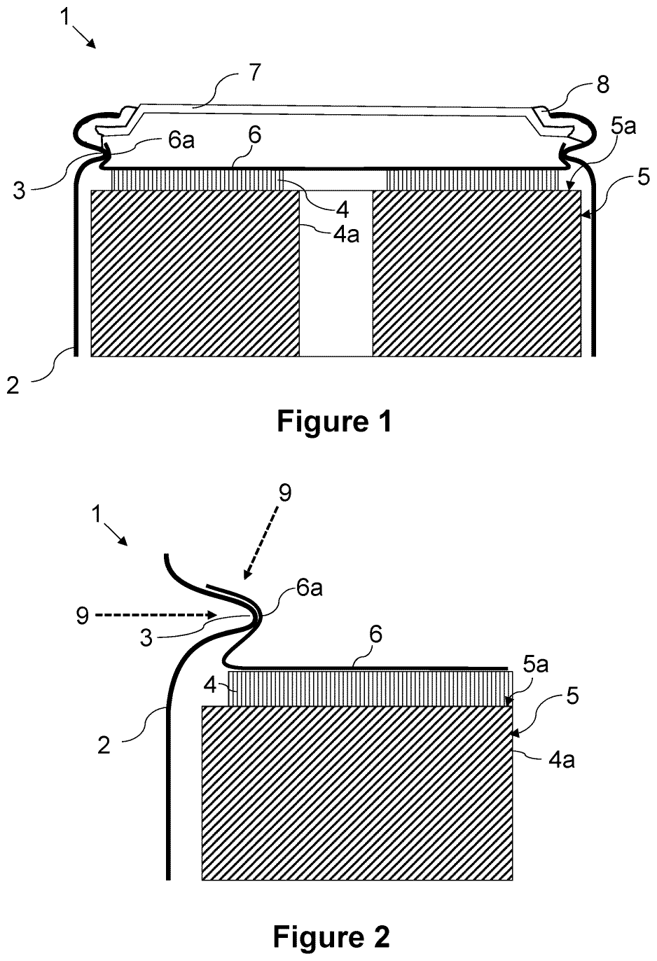

FIG. 1 shows a cross-sectional view of an example cylindrical secondary cell 1, wherein a current collector disc 6 (which may also be referred to as an ‘electrode lead plate’) is arranged in the cylindrical can 2 at the beading groove 3, and a jelly roll 5 is arranged below the beading groove 3.

The cylindrical secondary cell 1 comprises a cylindrical can 2 (also referred to simply as the ‘can 2’) having a beading groove 3 formed in a sidewall of the cylindrical can 2 and arranged around the circumference thereof.

The cylindrical secondary cell 1 further comprises a first conductive sheet 4, with first electrode coating 4a wound to form a jelly roll 5 which is arranged in the can 2.

In some examples, the cylindrical secondary cell 1 comprises a second conductive sheet with second electrode coating. The cylindrical secondary cell 1 may also comprise a separator sheet. The first conductive sheet 4 and the second conductive sheet, and optionally, the separator sheet, are wound to form the jelly roll 5. Alternatively, there are two separator sheets so that the first conductive sheet 4, a first separator sheet, the second conductive sheet and a second separator sheet are wound to form the jelly roll 5. It may also be the case that there is no separator sheet, for example if a solid electrolyte is used in the cylindrical secondary cell 1. For the purpose of the present disclosure, only the first conductive sheet 4, with first electrode coating 4a, is illustrated and discussed.

The first conductive sheet 4 comprises a portion free of first electrode coating 4a which protrudes on a first end side 5a of the jelly roll 5. Such a cylindrical secondary cell 1, with uncoated conductive sheet protruding on the end side of the jelly roll 5 is known as a ‘tabless cell’.

The cylindrical secondary cell 1 further comprises current collector disc 6 which is electrically conductive and arranged at the first end side 5a of the jelly roll 5 and in direct contact with at least part of the portion free of first electrode coating 4a of the first conductive sheet 4. In other words, and as can be seen in FIG. 1, the current collector disc 6 is arranged in the cylindrical can 2 directly against, and abutting, the at least part of the portion free of first electrode coating 4a of the first conductive sheet 4. The current collector disc 6 is arranged in direct electrical and physical contact with the first conductive sheet 4.

The current collector disc 6 comprises a peripheral flange 6a extending away from the jelly roll 5 and arranged along the peripheral edge of the current collector disc 6. The beading groove 3 is arranged on the cylindrical can 2 at a location that corresponds to the placement of the current collector disc 6. As can be seen in FIG. 1, and in more details in FIG. 2, the peripheral flange 6a of the current collector disc 6 matches and abuts the beading groove 3 at an apex thereof.

In other words, the current collector disc 6 has a protrusion along its edge, that protrudes on a side of the current collector disc 6 opposite the jelly roll 5. The protruding peripheral flange 6a thus points away from the jelly roll 5.

It should be noted that the peripheral flange 6a may not be continuous around the entire circumference of the current collector disc 6. The peripheral flange 6a may comprise several separate flanges arranged on the edge and directed away from the jelly roll 5. The peripheral flange 6a is, for example, made by stamping a flat current collector disc so that the edge is bent into the peripheral flange 6a. In some examples, the peripheral flange 6a may be provided with one or more slits to reduce the stress thereon during formation and/or during further bending/forming, e.g., if the peripheral flange 6a is further shaped so as to match and abut the apex of the beading groove 3.

As shown in FIGS. 1 and 2, a portion of the peripheral flange 6a is bent and pressed inwards by the lower side of the beading groove 3. It should also be noted that in FIG. 1, the flange looks to be bent so that it adopts a substantially S-shaped profile. It will be appreciated that such an example is purely illustrative and that the peripheral flange 6a may be bent inwards less or more than shown in FIGS. 1 and 2.

The cell 1 further comprises a lid 7 arranged to close an open end of the cylindrical can 2. The lid 7 in this example is crimped with a gasket 8 arranged therearound so as to form a watertight seal of the cylindrical can 2. However, in other examples, the lid 7 may be welded (e.g., laser welded) to the cylindrical can 2 to thereby close the cylindrical can 2, with or without a gasket 8 being arranged therearound.

The current collector disc 6 may be welded to the beading groove 3. In FIG. 2, optional welding directions for a welding laser 9 are shown. Welding the current collector disc 6 to the cylindrical can 2 at the beading groove 3 may comprise directing a welding laser 9 into an open end of the cylindrical can 2 such that a weld is formed on a surface of the beading groove 3 that faces said open end of the cylindrical can 2.

Additionally or alternatively, welding the current collector disc 6 to the cylindrical can 2 may comprise directing a welding laser 9 at an outer surface of the beading groove 3.

In FIG. 3, an alternative configuration of the beading groove 3 and the peripheral flange 6a is shown. In this example, the beading groove 3 and the peripheral flange 6a have a triangular profile.

It will be appreciated that such a profile may be more readily sized during a sizing process, i.e., by applying axial pressure to thereby reduce the height of the cylindrical can 2. Furthermore, the triangular profile of the beading groove 3 and the peripheral flange 6a allows for an ease of matching and abutting therebetween. Thus, the beading groove 3 and the peripheral flange 6a can be more readily welded together.

As with the configuration shown in FIG. 2, optional directions for a welding laser 9 are shown, to weld the current collector disc 6 to the cylindrical can 2 at the beading groove 3.

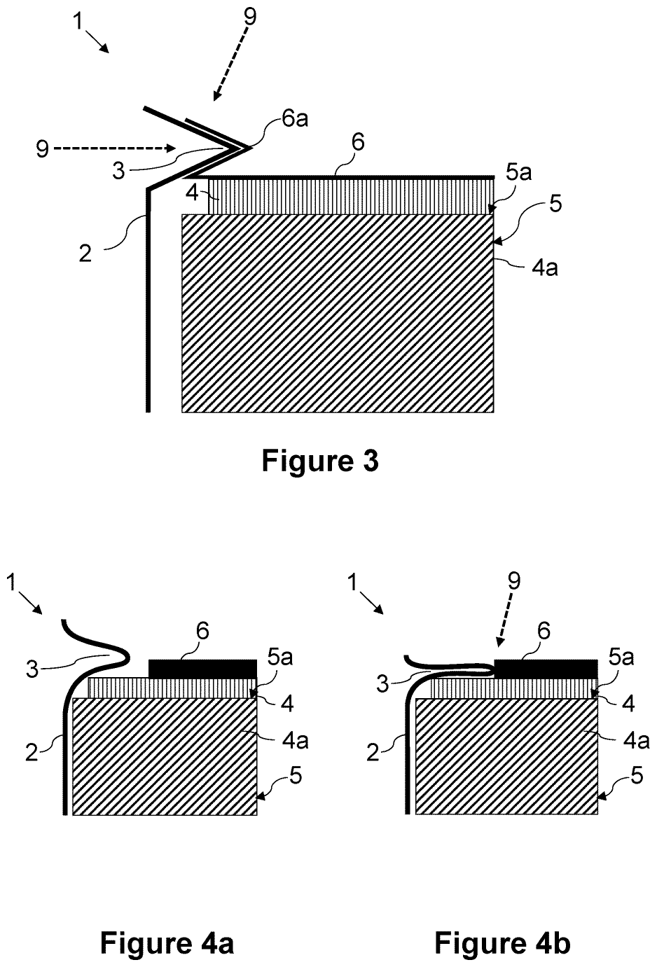

FIGS. 4a and 4b show an alternative configuration of the beading groove 3, wherein the current collector disc 6 does not comprise a peripheral flange. According to the illustrated configuration, the current collector disc 6 is sized such that the apex of the beading groove 3 abuts the edge of the current collector disc 6 after a sizing operation is performed on the cylindrical can 2.

That is, it can be seen in FIGS. 4a and 4b that the sizing operation performed on the cylindrical can 2 causes the beading groove 3 to axially collapse on itself and causes the apex of the beading groove 3 to move radially inwards towards the center of the cylindrical can 2, to thereby abut the current collector disc 6.

As shown in FIG. 4b, after the apex of the beading groove 3 abuts the current collector disc 6, these components may be welded together, such as with a welding laser 9 (shown as a dotted line).

By sizing the cylindrical can 2 in this way, as shown in FIGS. 4a and 4b, the overall dimensions

In another example, the apex of the beading groove 3 may abut the current collector disc 6 or a peripheral flange 6a thereof, before the sizing operation, and the sizing operation may cause the current collector disc 6 to be shaped by the moving inwards of the beading groove 3.

The beading groove 3 may be welded to the current collecting disc 6 before the sizing operation, e.g., using a welding laser directed from an outside of the cylindrical can 2 to an outer surface of the beading groove 3. Thereafter, the sizing operation applied to the cylindrical can 2 may cause the part of the beading groove 3 on which the welding laser was incident to be hidden or shrouded by the parts of the outer surface of the cylindrical can 2 on either side of the beading groove 3. Hence, any damage caused by the welding laser may be advantageously hidden by the sizing operation.

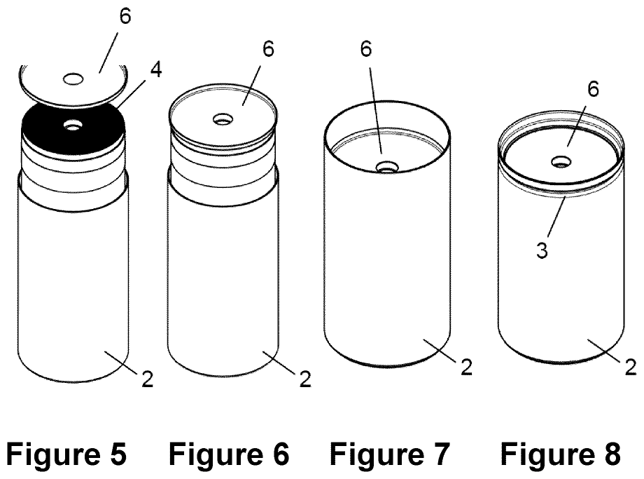

FIGS. 5 to 8 show different stages when the jelly roll 5 and current collector disc 6 are inserted into the cylindrical can 2. FIG. 5 shows a cylindrical can 2 where a jelly roll 5 is being inserted and a current collector disc 6 is being put on top. FIG. 6 shows when the current collector disc 6 has been arranged against the first end side 5a of the jelly roll 5. FIG. 7 shows when the jelly roll 5 and the current collector disc 6 have been inserted fully into the cylindrical can 2. FIG. 8 shows the cylindrical can 2 after beading and how the beading groove 3 is arranged relative to the peripheral flange of the current collector disc 6.

In FIG. 5, the dark end of the jelly roll 5 is the portion free of first electrode coating 4a (as shown in FIGS. 1 to 3) which protrudes on a first end side 5a of the jelly roll 5. Directly on top of it, the current collector disc 6 is arranged. It should be noted that in FIG. 4, the current collector disc 6 is not fully visible, but slightly cut off.

In FIG. 6, the current collector disc 6 has been arranged to abut the portion free of first electrode coating 4a. In some examples, the current collector disc 6 is welded to the portion free of first electrode coating 4a or in another way conductively attached to the portion free of first electrode coating 4a.

In FIG. 7, the jelly roll 5 and the current collector disc 6 have been arranged in the cylindrical can 2 and in FIG. 8, the cylindrical can 2 has been beaded so that the current collector disc 6 is shaped simultaneously with the beading process to as to match and abut the beading groove 3 at an apex thereof. It should be noted that the cylindrical secondary cell 1 is not finished here; the cylindrical can 2 is open over the current collector disc 6 and should be closed, for example by a lid 7 as further explained below.

By this cylindrical secondary cell 1, the current collector disc 6 can be secured in its position in the beading process. Also, the current collector disc 6 can be clamped between the jelly roll 5 and the beading groove 3 so that the current collector disc 6 holds the jelly roll 5 in position in the cylindrical can 2. Moreover, a greater electrical and mechanical contact surface can be achieved, thereby enabling a reliable welding between the current collector disc 6 and the cylindrical can 2.

Beading is a common method for cylindrical secondary cells where a groove is created in the cylindrical can 2 side. The beading groove 3 runs around the can 2 side. Beading may be used to form a shelf for holding a cap or lid 7 for closing an open end of the can 2 and it can also be used to form a stop which prevents the jelly roll 5 from moving in the can 2.

According to the presently described cylindrical secondary cell 1, the number of parts used, and the steps required for assembly can be minimized due to the current collector disc 6 being secured at the apex of the beading groove 3.

Furthermore, the (radial) size of the current collector disc 6 may be advantageously reduced as the contact between the current collector disc 6 and the cylindrical can 2 is configured to occur at the apex of the beading groove 3, which is the radially innermost point of the beading groove 3.

By further having a peripheral flange of the current collector disc 6 that matches and abuts the beading groove 3 at its apex, it can be ensured that there is good electrical contact between the current collector disc 6 and the cylindrical can 2, and the jelly roll 5 can be prevented from moving by the beading groove 3 and the current collector disc 6 if it is held or welded to the beading groove 3.

The current collector disc 6 comprises, for example, copper, when it is used on the positive side, i.e. the anode side, of the jelly roll 5. The current collector disc 6 comprises, for example, aluminum, when it is used on the positive side, i.e. the cathode side, of the jelly roll 5.

According to some aspects, as discussed above, the peripheral flange 6a of the current collector disc 6 is welded to the cylindrical can 2 at the beading groove 3. The welding can be done either before beading or after beading of the cylindrical can 2. In other words, in the method of assembling the cylindrical secondary cell described below, there might be an additional step of welding the peripheral flange 6a to the cylindrical can 2, either before or after beading.

The welding is for example done from the outside of the cylindrical can 2, which is especially beneficial if the welding is done after beading because it is easier to reach the welding location. The welding method can be any method suitable to weld the cylindrical can 2 to the current collector disc 6. The welding method is for example laser welding, ultrasonic welding, or resistance welding.

As can be seen in the illustrated examples, the current collector disc 6 may be in direct contact with the cylindrical can 2. By having the current collector disc 6 in direct electrical contact with the cylindrical can 2, the side of the can 2 may be used as a terminal for external loads and also, current can be led to either of the end sides of the cylindrical can 2 for having a terminal there. Thus, it is very flexible where to arrange the terminal.

According to some aspects, the current collector disc 6 comprises at least one slit arranged in the flange and at least the edge of the electrode lead plate 6. If the peripheral flange 6a of the current collector disc 6 is deformed by the beading groove 3, at least one slit may be used to reduce stress in the current collector disc 6 that may arise from the forces in the deformation. The at least one slit is for example cut out of the current collector disc 6. If the peripheral flange 6a is made in a stamping process, the at least one slit may be made before the stamping or in the same process.

The at least one slit may be formed on the peripheral flange 6a and may extend into the current collector disc 6 from the edge and inwards. According to some aspects, the at least one slit extends into the electrode lead plate between 1 and 20 mm, preferably between 1 and 10 mm. According to some aspects, the at least one slit has a width of between 0.5 and 4 mm, and preferably between 0.5 and 2 mm. As an example, the at least one slit extends into the disc, directed towards the center of the electrode lead plate, 5 mm and has a width of 1 mm.

An example that is not shown in the figures is that the cylindrical secondary cell 1 may comprise an insulating member arranged between the current collector disc 6 and the cylindrical can 2. In such a case, the terminal can be arranged on the end side of the cylindrical can 2 associated with the first end side 5a of the jelly roll 5. A terminal arrangement on the end side may be arranged in electrical contact with the current collector disc 6.

Alternatively to the process shown in FIGS. 5 to 8, the current collector disc 6 may be shaped to match the (to be formed) beading groove 3 before it is introduced into the cylindrical can 2.

Furthermore, in some examples, the cylindrical can 2 has a sizing process applied thereto (i.e., in a step following that shown in FIG. 7) so as to reduce the dimensions of the cylindrical can 2. It may be during such a process that the apex of the beading groove 3 is brought into abutment with the current collector disc 6, which may or may not have a peripheral flange 6a, instead of during the beading process.

While the present disclosure is susceptible to various modifications and alternative forms, specific examples are shown and described in relation to the drawings, with a view to clearly explaining the various advantageous aspects of the present disclosure. It should be understood, however, that the detailed description herein and the drawings attached hereto are not intended to limit the disclosure to the particular form disclosed. Rather, the intention is to cover all modifications, equivalents, and alternatives falling within the scope of the following claims, including the possible combination of various elements of these specific examples.

1. A cylindrical secondary cell (1) comprising:
a cylindrical can (2) comprising a beading groove (3) formed in a wall of the cylindrical can (2) and arranged around the circumference of the cylindrical can (2),
a first conductive sheet (4), with first electrode coating (4a), wound to form a jelly roll (5) which is arranged in the cylindrical can (2), and wherein the first conductive sheet (4) comprises a portion free of first electrode coating (4a) which protrudes on a first end side (5a) of the jelly roll (5), and
a current collector disc (6) which is electrically conductive and arranged at the first end side (5a) of the jelly roll (5) and in direct contact with at least part of the portion free of first electrode coating (4a) of the first conductive sheet (4),
wherein the current collector disc (6) abuts the apex of the beading groove.

2. The cylindrical secondary cell according to claim 1, wherein:
the current collector disc (6) comprises a peripheral flange (6a) extending away from the jelly roll (5), and
the peripheral flange (6a) of the current collector disc (6) is configured to match and abut the apex of the beading groove.

3. The cylindrical secondary cell (1) according to claim 2, wherein a portion of the peripheral flange of the electrode lead disc (6) is bent and pressed inwards, towards a center of the cylindrical can (2), by the beading groove (3).

4. The cylindrical secondary cell (1) according to claim 2, wherein the cylindrical can has an open end for receiving a lid, and the surface of the peripheral flange closest to the edge of the current collector disc (6) is angled towards said open end.

5. The cylindrical secondary cell (1) according to claim 1, comprising a lid (7), wherein the lid (7) rests on the beading groove (3).

6. The cylindrical secondary cell according to claim 2, wherein the current collector disc (6) comprises at least one slit (6a) arranged in the peripheral flange and at least the edge of the current collector disc (6).

7. The cylindrical secondary cell according to claim 2, wherein the entirety of the peripheral flange (6a) is in direct contact with the cylindrical can (2).

8. A method for assembling the cylindrical secondary cell (1) according to claim 1, wherein the assembling the cylindrical secondary cell (1) comprises:
arranging the jelly roll (5) in the cylindrical can (2),
arranging the current collector disc (6) in the cylindrical can (2) so that at least part of the portion (4a) free of first electrode coating (4a) of the first conductive sheet (4) is in direct contact with the current collector disc (6), and
beading the cylindrical can (2) to form the beading groove (3) so that the peripheral flange of the current collector disc (6), having a shape that matches the apex of the beading groove, abuts the beading groove (3) at least at said apex of the beading groove (3).

9. A method for assembling the cylindrical secondary cell (1) according to claim 1, wherein the assembling the cylindrical secondary cell (1) comprises:
arranging the jelly roll (5) in the cylindrical can (2), arranging the current collector disc (6) in the cylindrical can (2) so that at least part of the portion (4a) free of first electrode coating (4a) of the first conductive sheet (4) is in direct contact with the current collector disc (6), and
beading the cylindrical can (2) to form the beading groove (3) at a position on the cylindrical can (2) so that the peripheral flange of the current collector disc (6) is shaped by said beading thereby to match and abut the beading groove at least at the apex of the beading groove.

10. A method for assembling the cylindrical secondary cell (1) according to claim 1, wherein the assembling the cylindrical secondary cell (1) comprises:
arranging the jelly roll (5) in the cylindrical can (2),
arranging the current collector disc (6) in the cylindrical can (2) so that at least part of the portion (4a) free of first electrode coating (4a) of the first conductive sheet (4) is in direct contact with the current collector disc (6), and
beading the cylindrical can (2) to form the beading groove (3), and sizing the cylindrical can so that the current collector disc (6) abuts the beading groove (3) at least at said apex of the beading groove.

11. The method according to claim 8, further comprising: welding the current collector disc (6) to the cylindrical can (2) at the beading groove (3).

12. The method according to claim 11, wherein welding the current collector disc (6) to the cylindrical can (2) at the beading groove (3) comprises directing a welding laser into an open end of the cylindrical can.

13. The method according to claim 11, wherein welding the current collector disc (6) to the cylindrical can (2) at the beading groove (3) comprises directing a welding laser at an outer surface of the beading groove.

14. The method according to claim 9, further comprising: welding the current collector disc (6) to the cylindrical can (2) at the beading groove (3).

15. The method according to claim 14, wherein either:
welding the current collector disc (6) to the cylindrical can (2) at the beading groove (3) comprises directing a welding laser into an open end of the cylindrical can; or
welding the current collector disc (6) to the cylindrical can (2) at the beading groove (3) comprises directing a welding laser at an outer surface of the beading groove.

16. The method according to claim 9, further comprising: welding the current collector disc (6) to the cylindrical can (2) at the beading groove (3).

17. The method according to claim 16, wherein either:
welding the current collector disc (6) to the cylindrical can (2) at the beading groove (3) comprises directing a welding laser into an open end of the cylindrical can; or
welding the current collector disc (6) to the cylindrical can (2) at the beading groove (3) comprises directing a welding laser at an outer surface of the beading groove.

18. The cylindrical secondary cell (1) according to claim 3, wherein the cylindrical can has an open end for receiving a lid, and the surface of the peripheral flange closest to the edge of the current collector disc (6) is angled towards said open end.
